(19) United States
(12) Patent Application Publication
(10) Pub. No.: US 2007/0262126 A1
(43) Pub. Date: Nov. 15, 2007

(54) Article holder with postcard

(75) Inventors: Harry David Precheur, Sausalito, CA (US); Larry Shane Harmon, Sausalito, CA (US)

Correspondence Address: GRANT R CLAYTON;CLAYTON HOWARTH & CANNON, PC, P O BOX 1909, SANDY, UT, 84091-1909, US

(73) Assignee: Harry David Precheur

(21) Appl. No.: 11/786,518

(22) Filed: Apr. 11, 2007

Related U.S. Application Data
(63) Continuation-in-part of application No. 11/544,266, filed on Oct. 5, 2006.
(60) Provisional application No. 60/799,766, filed on May 12, 2006.

(51) Int. Cl. B42D 15/04

(52) U.S. Cl. 229/92.8

(57) ABSTRACT

A key card holder having a detachable card. The card may comprise a postcard with pre-paid postage or the postcard may include a voucher for free postage and mailing. A removably attached writing implement may be provided. The detachable card may further comprise a coupon, survey, map, checkout form, or an advertisement. Another aspect includes a hotel check-in kit comprising a key card and a postcard.

### CROSS-REFERENCE TO RELATED APPLICATIONS

This application is a continuation-in-part of U.S. patent application Ser. No. 11/544,266 filed on Oct. 5, 2006, which claims the benefit of U.S. Provisional Application No. 60/799,766, filed May 11, 2006, which are both hereby incorporated by reference herein in their entirety, including but not limited to those portions that specifically appear hereinafter, the incorporation by reference being made with the following exception: In the event that any portion of the above-referenced patent application or provisional application is inconsistent with this application, this application supercedes said above-referenced patent application or provisional application.

### STATEMENT REGARDING FEDERALLY SPONSORED RESEARCH OR DEVELOPMENT

Not Applicable.

### BACKGROUND OF THE INVENTION

1. The Field of the Invention

The present invention relates generally to items that are sent via a carrier, and more particularly, but not necessarily entirely, to postcards.

2. Description of Related Art

A postcard is typically a rectangular piece of thick paper or thin cardboard intended for mailing without an envelope. Postcards generally enjoy a lower postal rate than items mailed in an envelope. Postcards have traditionally included an artistic depiction on the front and a writing area on the back. The writing area allows the sender to compose a message to the recipient. In addition, on the back of the card there is a dedicated area for writing the recipient's address as well as a location for the sender to attach postage. For example, a sender may have to separately purchase and attach a stamp to the postcard. Alternatively, the postage may be included on the back of the postcard.

One drawback to using postcards is that the sender may have to separately locate a writing implement and the required postage even after the postcard has been obtained. This may be problematic, especially when the sender is on vacation or at a location that does not have postage or writing implements available. Further, even shops that sell postcards may not carry postage or writing implements.

In addition, at check-in at a hotel or motel, a guest is often given a key card electronically encoded to allow access to the guest's room. The hotel key card is often given to the guest in a key card holder. The key card holder may have a pocket or a holder for receiving the key card.

Despite the advantages of known postcards, improvements are still being sought. The present invention minimizes, and in some aspects eliminates, the failures of the presently available postcards, and other problems, by utilizing the methods and structural features described herein.

The features and advantages of the invention will be set forth in the description which follows, and in part will be apparent from the description, or may be learned by the practice of the invention without undue experimentation. The features and advantages of the invention may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1A illustrates a front view of an illustrative embodiment of the present invention;

FIG. 1B illustrates a back view of the illustrative embodiment of the present invention shown in FIG. 1A;

FIG. 1C illustrates a side view of the illustrative embodiment of the present invention shown in FIGS. 1A and 1B;

FIG. 2A illustrates a front view of another illustrative embodiment of the present invention;

FIG. 2B illustrates a back view of the illustrative embodiment of the present invention shown in FIG. 2A;

FIG. 2C illustrates a side view of the illustrative embodiment of the present invention shown in FIGS. 2A and 2B;

FIG. 3A illustrates a front view of another illustrative embodiment of the present invention;

FIG. 3B illustrates a back view of the illustrative embodiment of the present invention shown in FIG. 3A;

FIG. 3C illustrates a bottom view of the embodiment of the present invention shown in FIGS. 3A and 3B;

FIG. 4A illustrates a front view of another illustrative embodiment of the present invention;

FIG. 4B illustrates a back view of the illustrative embodiment of the present invention shown in FIG. 4A;

FIG. 4C illustrates a bottom view of the illustrative embodiment of the present invention shown in FIGS. 4A and 4B;

FIG. 5A illustrates a front view of another illustrative embodiment of the present invention;

FIG. 5B illustrates a back view of the illustrative embodiment of the present invention shown in FIG. 5A;

FIG. 5C illustrates a side view of the illustrative embodiment of the present invention shown in FIGS. 5A and 5B;

FIG. 6A illustrates a front view of another illustrative embodiment of the present invention;

FIG. 6B illustrates a back view of the illustrative embodiment of the present invention shown in FIG. 6A;

FIG. 6C illustrates a side view of the illustrative embodiment of the present invention shown in FIGS. 6A and 6B;

FIG. 7A illustrates a front view of another illustrative embodiment of the present invention;

FIG. 7B illustrates a back view of the illustrative embodiment of the present invention shown in FIG. 7A;

FIG. 7C illustrates a side view of the illustrative embodiment of the present invention shown in FIGS. 7A and 7B;

FIG. 8A illustrates a front view of another illustrative embodiment of the present invention;

FIG. 8B illustrates a back view of the illustrative embodiment of the present invention shown in FIG. 8A;

FIG. 8C illustrates a front view of the illustrative embodiment of the present invention shown in FIGS. 8A and 8B;

FIG. 8D illustrates a bottom view of the illustrative embodiment of the present invention shown in FIGS. 8A, 8B and 8C;

FIG. 9A illustrates a front view of another illustrative embodiment of the present invention;

FIG. 9B illustrates a back view of the illustrative embodiment of the present invention shown in FIG. 9A;

FIG. 9C illustrates a side view of the illustrative embodiment of the present invention shown in FIGS. 9A and 9B;

FIG. 10A illustrates a front view of another illustrative embodiment of the present invention;

FIG. 10B illustrates a back view of the illustrative embodiment of the present invention shown in FIG. 10A;

FIG. 10C illustrates a side view of the illustrative embodiment of the present invention shown in FIGS. 10A and 10B;

FIGS. 11A-11D illustrate an illustrative method for forming a postcard with an attached writing implement;

FIG. 12A illustrates a front view of another illustrative embodiment of the present invention;

FIG. 12B illustrates a top view of the illustrative embodiment of the present invention shown in FIG. 12A;

FIG. 13 illustrates a front view of another illustrative embodiment having a key card holder and detachable postcard;

FIG. 14 illustrates a rear view of the illustrative embodiment of the present invention shown in FIG. 13;

FIG. 15 illustrates a front view of another illustrative embodiment of the present invention having a key card holder, detachable postcard, and writing implement;

FIG. 16 illustrates a front view of another illustrative embodiment of the present invention having a key card holder, detachable postcard, and writing implement; and

FIG. 17 illustrates a front view of another illustrative embodiment of the present invention having a key card holder and multiple detachable cards.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly-dictates otherwise. As used herein, the terms “comprising,” “including,” “containing,” “characterized by,” and grammatical equivalents thereof are inclusive or open-ended terms that do not exclude additional, unrecited elements or method steps.

Applicants have invented a novel postcard that includes a detachable writing implement for writing on the postcard. The invention further contemplates a bound set of postcards having a detachable writing implement. The writing implement may be removably attached to the postcard in various manners as described herein. It will be appreciated that the invention may include postcards and writing implements of varying size, design, shape and color. Typically, a postcard falling within the scope of the applicants' invention includes a picture or logo on the front side and space to write a message on the back side along with a location to address the postcard to the recipient. However, the postcard may also have one or more folds whereby opposing surfaces of the postcard may be doubled up so that one surface lies on the other surface.

Further, it is within the scope of the present invention to replace the postcard with a greeting card, which is a type of folded card featuring a message of greeting or other sentiment. They are usually given on special occasions such as birthdays, special occasions (graduation, baby birth, thank you, etc.), Christmas or other holidays. For example, a birthday card having a detachable writing implement should be considered to fall within the scope of the present invention. Stationary may also be used without departing from the scope of the present invention. Stationary with a detachable writing implement should also be considered to fall within the scope of the present invention. Thus, as used herein, the term “postcard” means any of the following: postcards, greeting cards, stationary, note cards, message cards, whether they be of the folded or unfolded variety, as well as any material upon which messages can be imposed of any size, shape, texture or weight.

It will further be appreciated that the term “writing implement” as used herein may include any type of pen, pencil or other type of device capable of writing, sketching, marking or coloring on the surfaces of the postcard. It should be noted that most any type of handheld writing implement may be utilized by the present invention.

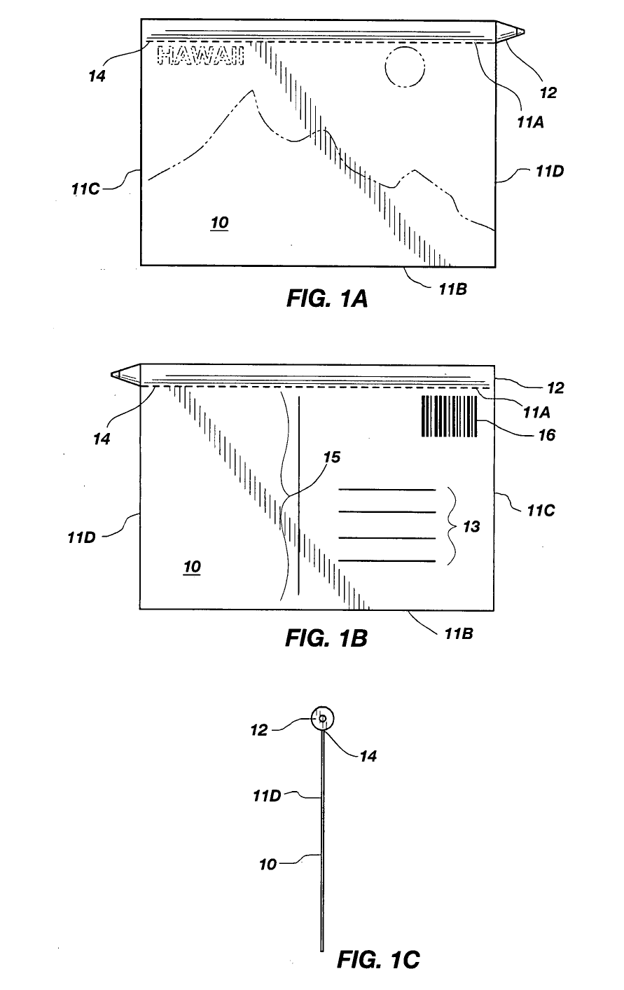

Referring now to FIGS. 1A, 1B and 1C, there is shown a front view, a back view and a side view, respectively, of a postcard 10 pursuant to one embodiment of the present invention. The postcard 10 has a generally rectangular shape and includes a top edge 11A, a bottom edge 11B and two opposing side edges 11C and 11D. As shown in FIG. 1A, depicted on the front of postcard 10 is picture of a landscape scene from Hawaii. Conveniently disposed along the top edge 11A of the postcard 10 is a writing implement 12. The writing implement 12 is attached to the top edge 11A of postcard 10 along a perforation 14, which functions are a separation structure. The perforation or separation structure 14 extends laterally between the opposing side 11C and 11D of the postcard 10.

The perforation or separation structure 14 comprises small holes, indentations or scoring to aid in the separation of the writing implement 12 from the top edge 11A of the postcard 10. The perforation 14 weakens the material that forms the postcard 10 along a predetermined tear line. Thus, as used herein, the term “perforation” means a creation of a structure holding two objects together to facilitate the purposeful separation of the objects, such as by weakening of the structure, including but not limited to cut holes, punctures,-and scoring. Further, as will be appreciated by one having ordinary skill in the art, the size of the holes, punctures and scoring may vary in the perforation or separation structure 14 to accomplish the purposes set forth herein. It is also within the scope of the present invention to include structure(s) allowing the removal and reattachment of the writing implement. Such separation structures can be readily arrived at my those skilled in the art using the disclosure provided herein. Such separation structures may include perforations, holes, punctures, scoring or other structures and configurations which perform functions which are similar or equivalent those described and suggested herein.

The writing implement 12 is preferably removed by a person gripping the writing implement 12 in one hand, and holding the postcard 10 in the other, and then tearing along the perforation or separation structure 14 along the top edge 11A. The tearing is accomplished by pulling the writing implement 12 away from the top edge 11A of the postcard 10. This may include a shearing force being applied at the tear point on the perforation or separation structure 14.

Prepaid postage 16 is also included on the back of the postcard 10 as shown in FIG. 1B. The prepaid postage 16 is in the form of machine readable marking, such as a bar code or any other type of machine readable marking used to denote postage. In addition, regular postage stamps may be used, if needed. The cost of the prepaid postage 16 is generally included in the price of the card. It will be appreciated that the use of prepaid postage 16 eliminates the need for the purchaser of the postcard 10 to separately purchase postage in order to send the postcard 10. It will be understood that it is within the scope of the present invention to use prepaid postage that will allow a user to deposit the postcard with any postal service, or nearly any postal service, in the world which will satisfy the postal service to deliver the postcard anywhere in the world. It will be appreciated the significant advantage which such universal postage provides to the user.

The postage 16 is prepaid in a sufficient amount for the desired carrier to deliver the postcard 10 anywhere in the world. As used herein, the term “carrier” means a domestic or international postal service operated by a governmental entity for the collection, processing and distribution of letters, packages and other mail, and for related postal services. The Unites States Post Office is an example of a governmental carrier. The term “carrier” also includes commercial packaging and mailing services. Examples of a commercial carrier includes Federal Express, United Parcel Services, DHL and others.

The postcard 10 may include prepaid postage 16 in the amount of an international postage rate, or a domestic postal rate. The amount of postage will vary with differences in the size of the postcard and location to which it is being sent. The prepaid postage 16 may be in an amount equal to the highest international rate such that the postcard 10 can be mailed to anywhere in the world. Thus, the sender will not have any restrictions on where the postcard 10 can be sent.

Also located on the back of the postcard 10 is a first portion, indicated by the area denoted by a bracket 13, for addressing the postcard 10 to the recipient. In this location, the address of the recipient is written. A second portion, indicated by the area denoted with a bracket 15, on the back of the postcard 10 is suitable for the sender to write a short message to the recipient if desired.

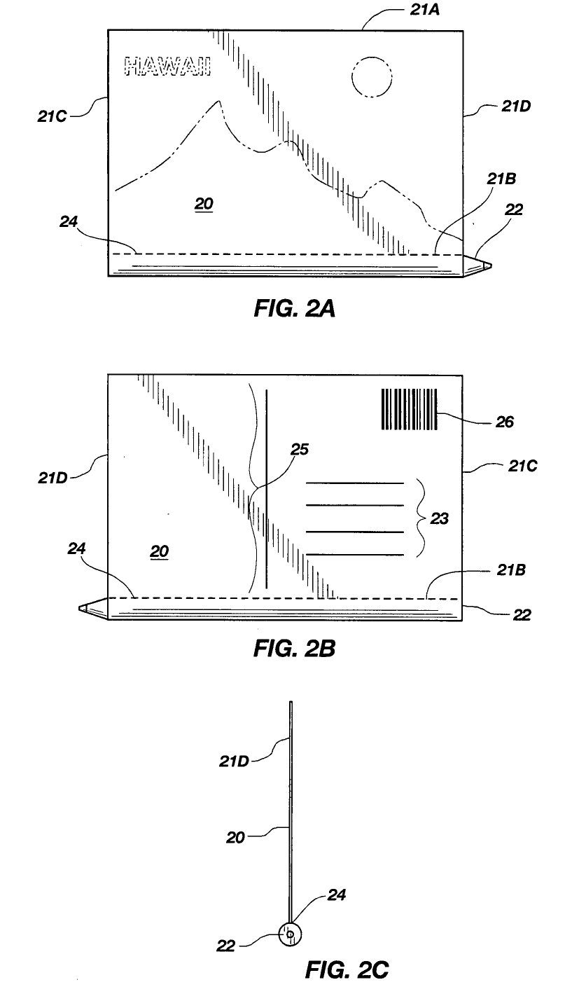

Referring now to FIGS. 2A, 2B and 2C, there is illustrated a front view, a back view, and a side view, respectively, of a postcard 20 according to another embodiment of the present invention. Similar to the embodiment described previously in FIGS. 1A, 1B, and 1C, postcard 20 includes a top edge 21A, a bottom edge 21B, and two opposing side edges 21C and 21D. In addition, in the same manner as described above, postcard 20 includes a first portion, the area denoted by bracket 23, for addressing the postcard 20 to the recipient, a second portion, the area denoted by the bracket 15, for writing a short message to the recipient, and prepaid postage 26 on the back of the postcard 20 as shown in FIG. 2B. A writing implement 22 is removably attached to postcard 20 along the bottom edge 21B of the postcard 20. As previously described, the writing implement 22 is detached from the postcard 20 via a perforation or separation structure 24 extending between the two opposing edges 21C and 21D.

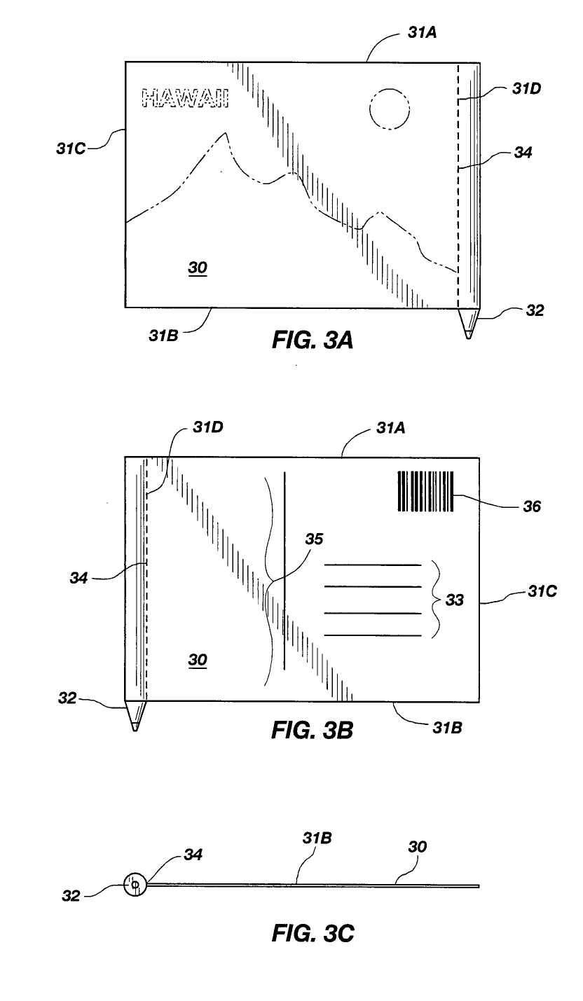

Referring now to FIGS. 3A, 3B and 3C, there is illustrated a front view, a back view, and a bottom view, respectively, of a postcard 30 according to another embodiment of the present invention. Similar to the embodiments described previously, postcard 30 includes a top edge 31A, a bottom edge 31B, and two opposing side edges 31C and 31D. In addition, in the same manner as described above, postcard 30 includes a first portion, the area denoted by the bracket 33, for addressing the postcard 30 to the recipient, a second portion, the area denoted by the bracket 35, for writing a short message to the recipient, and prepaid postage 36 on the back of the postcard 30, all shown in FIG. 3B.

A writing implement 32 is removably attached to the postcard 30 along the side edge 31D of the postcard 30. Again, the writing implement 32 is detached via a perforation or separation structure 34 in the same manner as previously described.

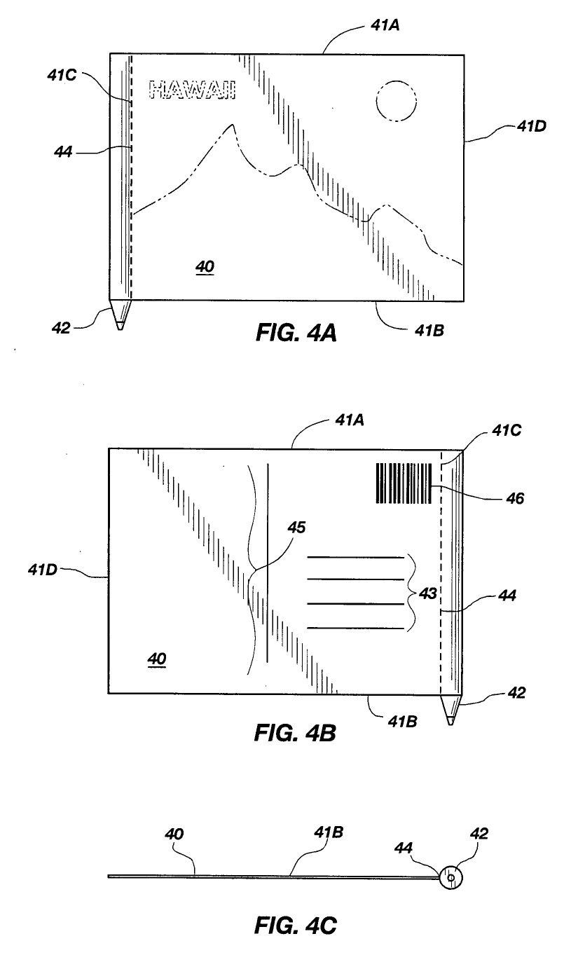

Referring now to FIGS. 4A, 4B and 4C, there is illustrated a front view, a back view, and a bottom view, respectively, of a postcard 40 according to another embodiment of the present invention. Similar to the embodiments described previously, postcard 40 includes a top edge 41A, a bottom edge 41B, and two opposing side edges 41C and 41D. In addition, in the same manner as described above, postcard 40 includes a first portion, the area denoted by bracket 43, for addressing the postcard 40 to the recipient, a second portion, the area denoted by bracket 45, for writing a short message to the recipient, and prepaid postage 46 on the back of the postcard 40, all shown in FIG. 4B. A writing implement 42 is removably attached to the postcard 40 along the side edge 41C of the postcard 40. Again, the writing implement 42 is detached from the postcard 40 via a perforation or separation structure 44 in the same manner as previously described.

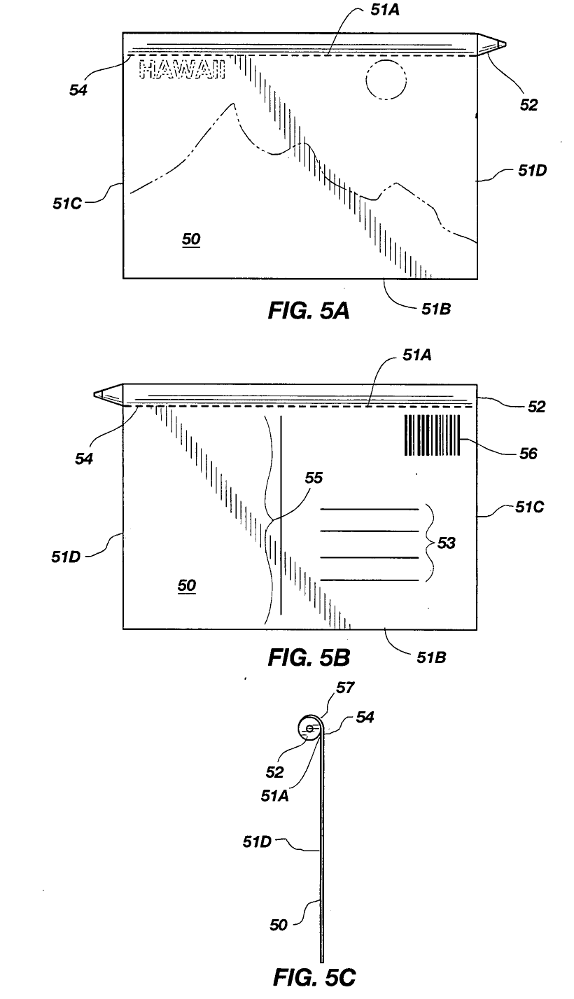

Referring now to FIGS. 5A, 5B and 5C, there is illustrated a front view, a back view, and a bottom view, respectively, of a postcard 50 according to another embodiment of the present invention. Similar to the embodiments described previously, postcard 50 includes a top edge 51A, a bottom edge 51B, and two opposing side edges 51C and 51D. In addition, in the same manner as described above, postcard 50 includes a first portion, the area denoted by bracket 53, for addressing the postcard 50 to the recipient, a second portion, the area denoted by bracket 55, for writing a short message to the recipient, and prepaid postage 56 on the back of the postcard 50, all shown in FIG. 5B. A writing implement 52 is removably attached to a postcard 50 along the top edge 51A of the postcard 50.

As best shown in FIG. 5C, extending from the top edge 51A of the postcard 50, is a portion 57 that wraps around the writing implement 52. This portion 57 is formed from the same material that the card 50 is made of. The portion 57 that wraps around the writing implement 52 holds it securely to the postcard 50. During manufacture, the writing implement 52 is wrapped in the portion 57. One method includes rolling up the writing implement 52 in the portion 57. The writing implement 52 is detached from the postcard 50 via a perforation or separation structure 54 in the same manner as previously described.

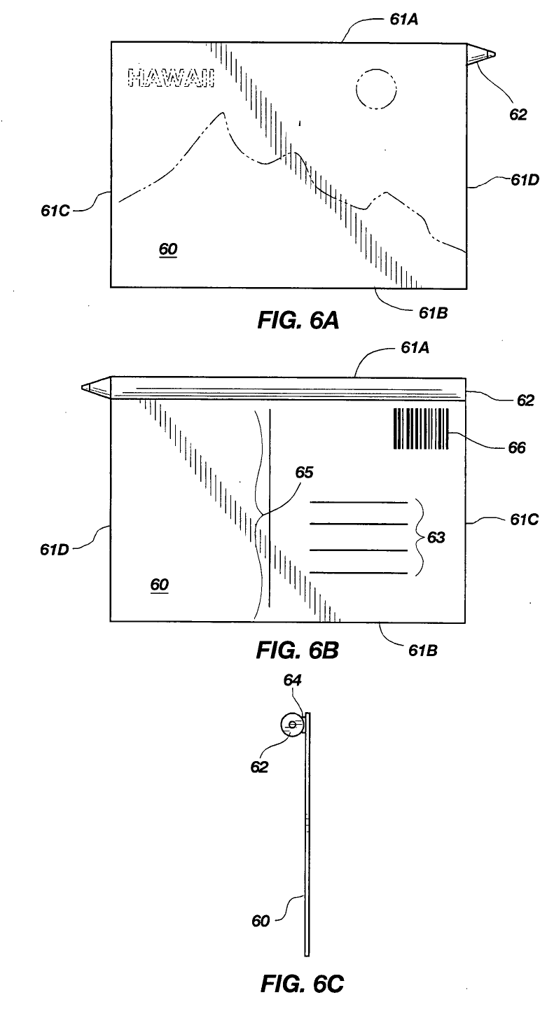

Referring now to FIGS. 6A, 6B and 6C, there is illustrated a front view, a back view, and a side view, respectively, of a postcard 60 according to another embodiment of the present invention. Similar to the embodiments described previously, postcard 60 includes a top edge 61A, a bottom edge 61B, and two opposing side edges 61C and 61D. In addition, in the same manner as described above, the postcard 60 includes a first portion, the area denoted by bracket 63, for addressing the postcard 60 to the recipient, a second portion, the area denoted by bracket 65, for writing a short message to the recipient, and prepaid postage 66 on the back of the postcard 60, all shown in FIG. 6B.

A writing implement 62 is removably attached to a postcard 60 just below the top edge 61A of the postcard 50 on the back of the postcard 60. In this case, the writing implement 62 is attached via an adhesive 64 applied between the writing implement 62 and the postcard 60 as best seen in FIG. 6C. The adhesive 64 should be of the type to release the writing implement 62 when a user grips the writing implement 62 in one hand, and purposely pulls the writing implement 62 away from the postcard 60.

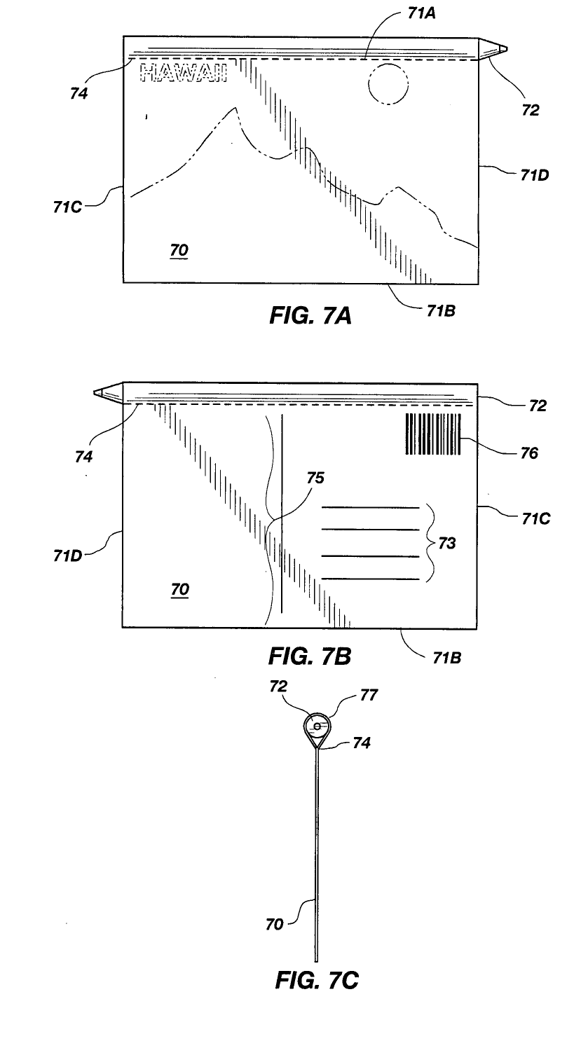

Referring now to FIGS. 7A, 7B and 7C, there is illustrated a front view, a back view, and a side view, respectively, of a postcard 70 according to another embodiment of the present invention. Similar to the embodiments described previously, postcard 70 includes a top edge 71A, a bottom edge 71B, and two opposing side edges 71C and 71D. In addition, in the same manner as described above, postcard 70 includes a first portion, the area denoted by bracket 73, for addressing the postcard 70 to the recipient, a second portion, the area denoted by bracket 75, for writing a short message to the recipient, and prepaid postage 76 on the back of the postcard 70, all shown in FIG. 7B. A writing implement 72 is removably attached to a postcard 70 along the top edge 71A of the postcard 70 in the manner described below.

As shown in FIG. 7C, the postcard 70 is formed by a single piece of stock postcard material. The material is doubled together to form a fold 77. The material may be attached together with adhesive to form the front and back of the postcard 70. The writing implement 72 is located in the fold 77, and the material wraps completely around the writing implement. A perforation or separation structure 74 is employed to allow the writing implement 74 to be removed from the postcard 70.

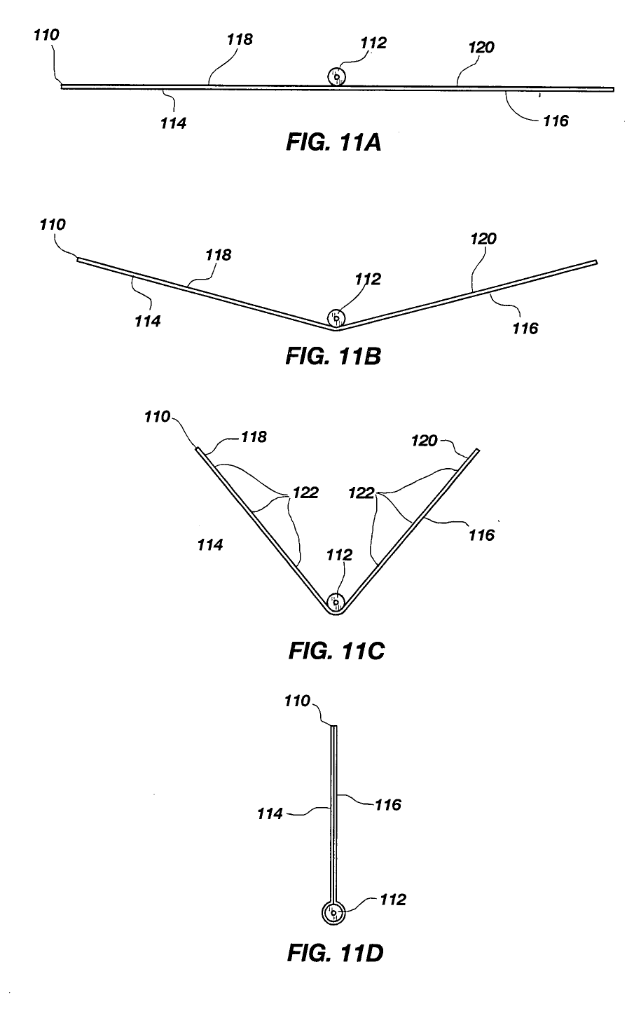

The steps described above are illustrated in more detail in FIGS. 11A-11D. In FIG. 11A, there is shown a side view of a piece of stock postcard material 110 for making a postcard. The material 110 is laid flat in a horizontal orientation. The material 110 includes a front 114 and a back 116 for the postcard located on the same side of the material 110. On the opposite side of the material 110 is a left inner surface 118 and a right inner surface 120. In order to form the postcard from the material 110, the following steps are necessary. First, a writing implement 112 is placed in the center of the material 110 as shown in FIG. 11A. Alternatively, the writing implement 112 may be placed into a fold or a sleeve that has already been created. As shown in FIG. 11B, the material 110 is folded such that the surfaces 118 and 120 begin to come together. Surfaces 118 and 120 are coated with an adhesive 122 as shown in FIG. 11C. Finally, the surfaces 118 and 120 are brought into contact with one another as shown in FIG. 11D. The adhesive 122 binds the surfaces 118 and 120 together. The writing implement 112 stays in the folded portion or, in the alternative embodiment, is now placed into the fold or sleeve. This forms a postcard from the material 110 of the type shown in FIGS. 7A-7C. A subsequent step may include adding a perforation or separation structure such that the writing implement 112 can be detached from the postcard as previously described. Additionally, the front 114 and the back 116 areas of the postcard can be pre-printed on the stock material 110 with the appropriate artwork and information.

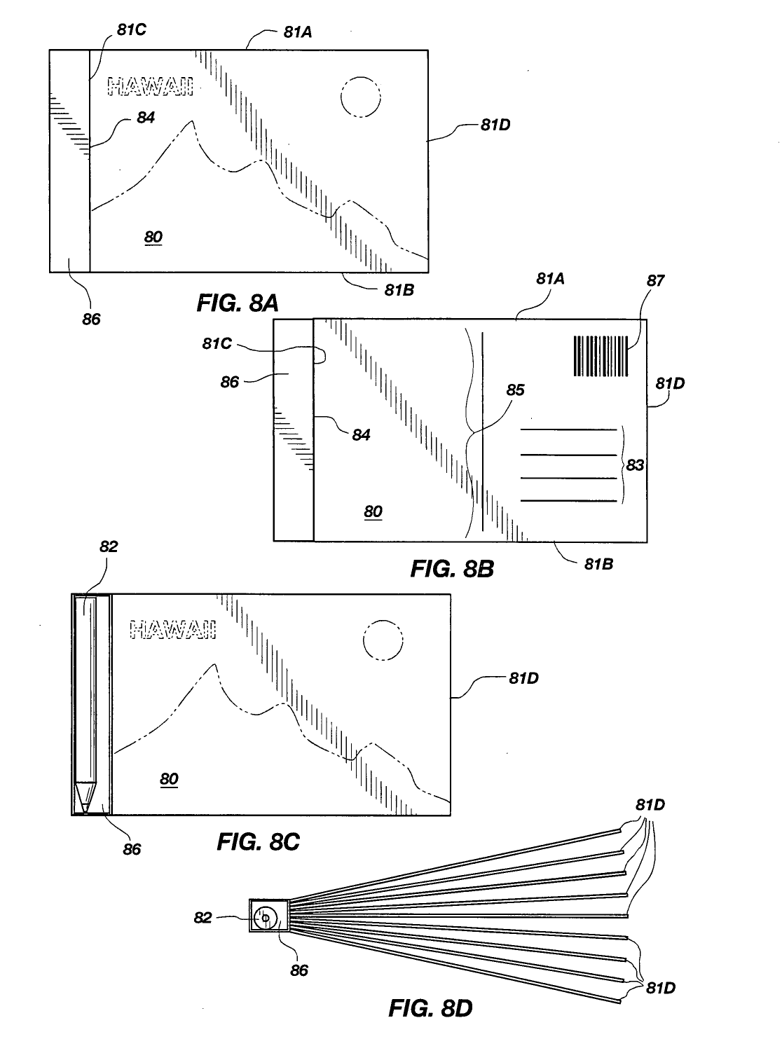

Referring now to FIGS. 8A, 8B, 8C, and 8D, there is shown a front view, a back view, a front view, and a bottom view, respectively, of a multi-pack version of still another embodiment of the present invention that includes a plurality of postcards 80 in a booklet form. Each of the postcards 80 includes a top edge 81A, a bottom edge 81B, and opposing side edges 81C and 81D. In addition, in the same manner as described above, postcard 80 includes a first portion, the area denoted by bracket 83, for addressing the postcard 80 to the recipient, a second portion, the area denoted by bracket 85, for writing a short message to the recipient, and prepaid postage 87 on the back of the postcard 80, all shown in FIG. 80B.

The postcards 80 are commonly bound along their side edges 81C by a binding 86. Separating each of the postcards 80 and the binding 86 is a perforation or separation structure 84. The perforation or separation structure 84 allows each of the postcards 80 to be individually detached from the binding 86 as needed. Located in a receptacle in the interior of the binding 86 is a writing implement 82 as shown in FIGS. 8C and 8D. The writing implement 82 may be conveniently stored in the binding 86 until needed. Once finished with the writing implement 82, it may be returned to the binding 86 for future use.

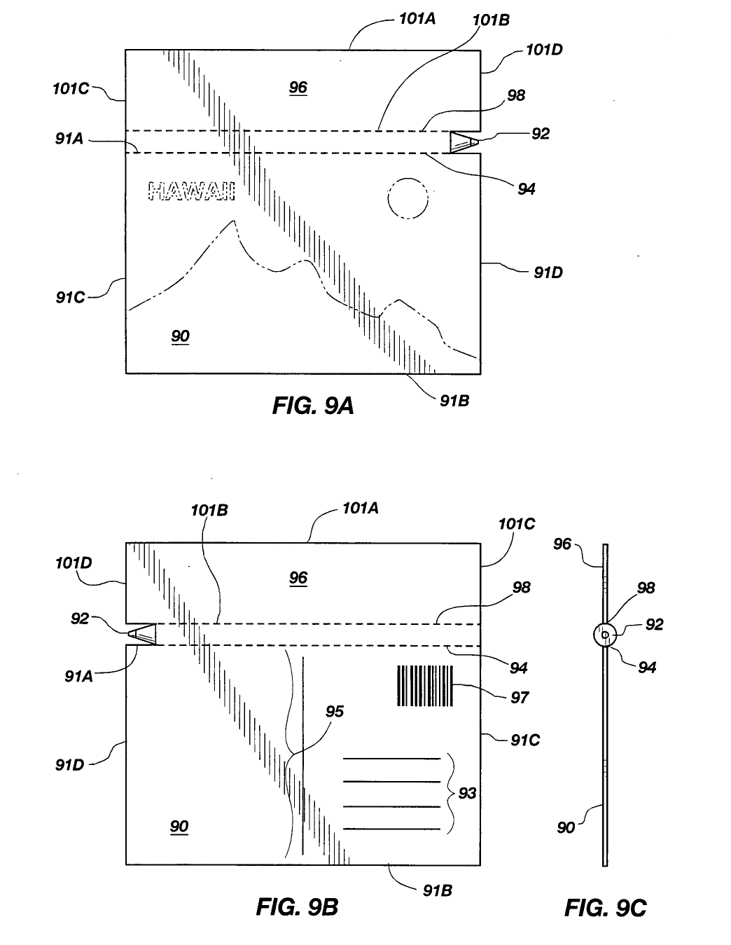

Referring now to FIGS. 9A, 9B and 9C, there are shown yet another illustrative embodiment of the present invention. A front view, a back view and a side view of a postcard 90 are shown in FIGS. 9A, 9B, and 9C, respectively. The postcard 90 includes a top edge 91A, a bottom edge 91B, and opposing side edges 91C and 91D. In addition, in the same manner as described above, postcard 90 includes a first portion, the area denoted by bracket 93, for addressing the postcard 90 to the recipient, a second portion, the area denoted by bracket 95, for writing a short message to the recipient, and prepaid postage 97 on the back of the postcard 90, all shown in FIG. 9B. A writing implement 92 is attached along the top edge 91A of the postcard 90. A perforation or separation structure 94 facilitates separating the writing implement 92 from the postcard 90 as previously described.

Disposed above the writing implement 92 is a second card 96. The second card 96 includes a top edge 101A, a bottom edge 101B, and two opposing side edges 101C and 101D. The second card 96 may be smaller than the postcard 90. The bottom edge 101B is attached to the writing implement 92. A perforation or separation structure 98 separates the second card 96 and the writing implement 92. The perforation or separation structure 98 serves to allow the second card 96 to be detached from the writing implement 92.

The second card 96 may serve as a bookmark, a coupon, mini-picture, advertising space, sticker, fridge-magnet, novelty magnet, magnet, or describe the images on the actual postcard 90. Typically, the second card is not sent to the recipient of the postcard 90 but instead is retained by the sender. In addition, the second card 96 may contain secondary information, patent information, UPC bar codes, name, price, details, marketing graphics, and general information to be displayed by the provider or seller to the end users of the postcard 90.

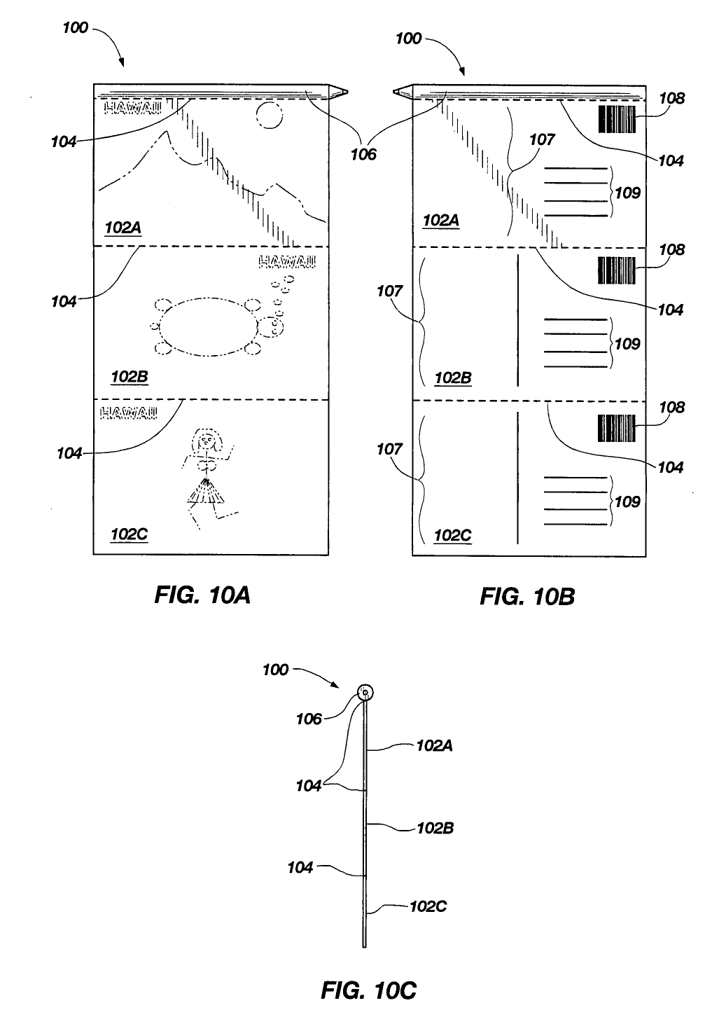

Referring now to FIGS. 10A-10C, there is shown another embodiment of the present invention in the form of a multi-pack 100. The multi-pack 100 includes three (3) postcards 102A, 102B and 102C stacked in a top-to-bottom configuration. That is, the bottom of postcard 102A is connected to the top postcard 102B, while the bottom of postcard 102B is connected to the top of postcard 102C. Any number of additional postcards can-be included in the same manner.

Perforations or separation structures 104 allow the postcards 102A, 102B and 102C to be detached from one another. A writing implement 106 is attached to the top edge of postcard 102A. Again, perforation or separation structure 104 allows the writing implement to be detached from the postcard 102A. On the back of each of the postcards 102A, 102B and 102C, see FIG. 10B, prepaid postage 108 is included. Each postcard 102A, 102B, and 102C further includes a first portion, the areas denoted by brackets 109, for addressing the postcards 102A, 102B and 102C to the recipients, and a second portion, the area denoted by brackets 107, for writing a short message to the recipients, if desired. It is within the scope of the present invention that postcards be attached in a side-to-side configuration.

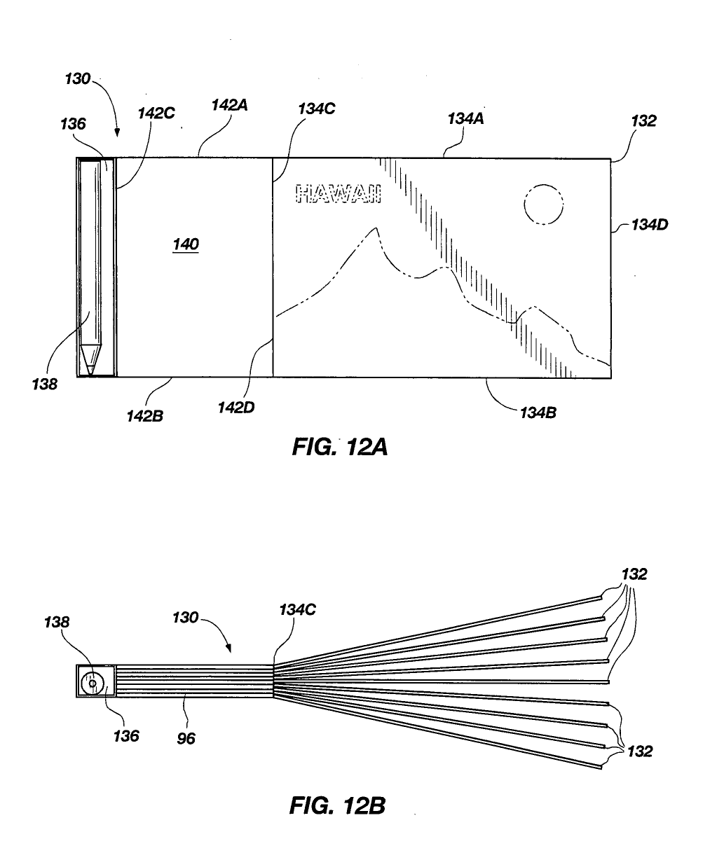

Referring now to FIGS. 12A and 12B, there is shown another embodiment of a multi-pack 130 in a front view and a top view, respectively. Multi-pack 130 includes a plurality of postcards 132. Each of the postcards 132 is generally rectangular in shape and includes a top edge 134A, a bottom edge 134B, a left side edge 134C and a right side edge 134D. The postcards 132 are bound in a booklet form by a binding 136. Located within the binding 136 is a writing implement 138. As previously described, the writing implement 138 is removable from the binding 136 in order to allow a user to write on the postcards 132. The writing implement 138 may be returned to the binding 136 for future use and storage.

Interposed between each of the postcards 132 and the binding 136, is a second card 140. The second card 140 includes a top edge 142A, a bottom edge 142B, and two opposing side edges 142C and 142D. The second cards 140 may be smaller than the postcards 132. The side edge 142C of each of the second cards 140 is attached to the binding 136. A perforation or separation structure along the length of the side edge 142C permits the second card 140 to be detached from the binding 136 by tearing the perforation or separation structure.

Each of the second cards 140 and the postcards 132 share a common edge formed by a side edge 142D of the second cards 140 and a left side edge 134C of the postcards 132. A perforation or separation structure along the length of this common edge will allow the postcards 132 to be detached from their respective second cards 140. In this manner, the postcards 132 may be individually removed from the multi-pack.

The second cards 140 may serve as a bookmark, a coupon, mini-picture, advertising space, sticker, fridge-magnet, or include text that describes the images on the actual postcards 132. Typically, the second cards 140 are not sent to the recipient of the postcard 132 but are instead retained by the sender. In addition, the second cards 140 may contain secondary information, patent information, UPC bar codes, name, price, details, marketing graphics, and general information to be displayed by the provider or seller to the end users of the postcards 132. The second cards 140 may detach or remain fixed to the binding 136. Although not shown, the backside of each of the postcards 132 may include an area for addressing the postcards 132 to a recipient, an area for writing a short message to the recipient, and prepaid postage.

Referring now generally to the present invention, it will be noted, that the present invention may be used as a souvenir and may not require any packaging material. Also, the present invention may be displayed on a stand having a receptacle for storing the cards, a flat writing area, and a mail slot. The stand may be placed in high traffic areas. In this manner, the present invention provides a one place stop for sending a postcard. The present invention further provides a prepaid-postage postcard and writing implement as an all-in-one package. The package may be sold as its own product, utilized as an advertisement or as a promotional item, or otherwise provided to the public.

It will be appreciated that many tourists, visitors, travelers, sightseers, vacationists and others often find themselves in a location that is interesting and unique and often devote time and energy into communicating with family, friends, and loved ones through a postcard that is indicative of that location. However, many times it is difficult for these people to either locate or take the time to: find a postcard at one location, then find a writing implement, and then finally finding a second location to purchase postage sufficient in amount to send the postcard all over the world to loved ones. The present invention is meant to solve these problems by providing the convenient, all-in-one package containing a postage prepaid postcard, sufficient in amount to send the postcard all over the world, and a writing implement.

It will be appreciated that the packaged product that is the invention may be sold at a number of various locations, each location having its own unique attraction(s). For example, the invention may be sold on cruise ships, bus tours, bike tours, museum tours, at shows, novelty tours, etc. One particular location which the invention may be used universally is in hotels. Individuals staying at hotels are often interested in communicating with loved ones in various parts of the world and often turn their attention toward sending postcards. For example, the present invention may be sold in hotel rooms, at mini-bars, at the front desks of hotels, at hotel spas, at banquet space/convention center/Expo in hotels, at restaurants and bars in hotels and in the gift shops of hotels.

Further, it will be appreciated that there are many additional locations that the invention may be sold and utilized. Examples include, (I) selling the product at merchandising stands and points of retail activity at concerts and entertainment venues with the entertainment entity name and/or logo or the venue on the postcard; (ii) in college bookstores; (iii) at concession stands for professional, college or school sporting events with logo, name or mascot represented; (iv) at scenic locations with scenic location on card; (v) at various “Points of Interest,” such as Golden Gate Bridge, Sydney Opera House, or the Grand Canyon; (vi) in bookstores, such as Barnes and Noble; (vii) in coffee shops, such as STARBUCKS;® (viii) in waiting rooms at doctors' offices, or oil changing stations; (ix) in bars with a promotional paid for drink attached; and (x) in vending machines at all locations.

The invention may also be given away as inserts in magazines, booklets and newspapers, or may be sold with a blank face for printing a photo from a computer or a digital camera thereon, or may be given away by special interest groups such as GREENPEACE,® SIERRA CLUB,® etc. to convey a purpose or meaning. As illustrated, the present invention has many uses and may be reduce the time and energy for a person to locate a postcard, postage and writing implement to send a loved one a note.

Embodiments of the present invention thus can be sold or otherwise distributed in any of the following locations: mini-bar, front desk of hotel, spas, banquet space/convention center in hotel, restaurant and bars, gift shops, cruise ships, bus tours, bike tours, museum tours, shows, novelty tours, souvenir shops, retail stores, merchandising stands, points of retail activity at concerts and entertainment venues, college bookstores, concession stands for professional, college, and other sporting events; scenic locations, waiting rooms, bars, vending machines, as inserts in magazines, booklets and newspapers, as fund raisers, special interest groups (for example, GREENPEACE,® SIERRA CLUB,® HABITAT FOR HUMANITY,® etc.). The illustrative embodiments of the invention may also be given away for free, the cost being absorbed by advertising on available space on postcard and pen. The illustrative embodiments of the invention may also be given away for free promotions. The illustrative embodiments of the invention may also include a gift certificate or coupon.

It will be appreciated that all the structures and apparatus disclosed herein are merely one example of a means for coupling a writing implement to a postcard, and it should be appreciated that any structure, apparatus or system for coupling a writing implement to a postcard which performs functions the same as, or equivalent to, those disclosed herein are intended to fall within the scope of a means for coupling a writing implement to a postcard, including those structures, apparatus or systems for coupling a writing implement to a postcard which are presently known, or which may become available in the future. Anything which functions the same as, or equivalently to, a means for coupling a writing implement to a postcard falls within the scope of this element.

Those having ordinary skill in the relevant art will appreciate the advantages provide by the features of the present disclosure. For example, it is a feature of the present disclosure to provide a combined postcard and writing implement with prepaid postage.

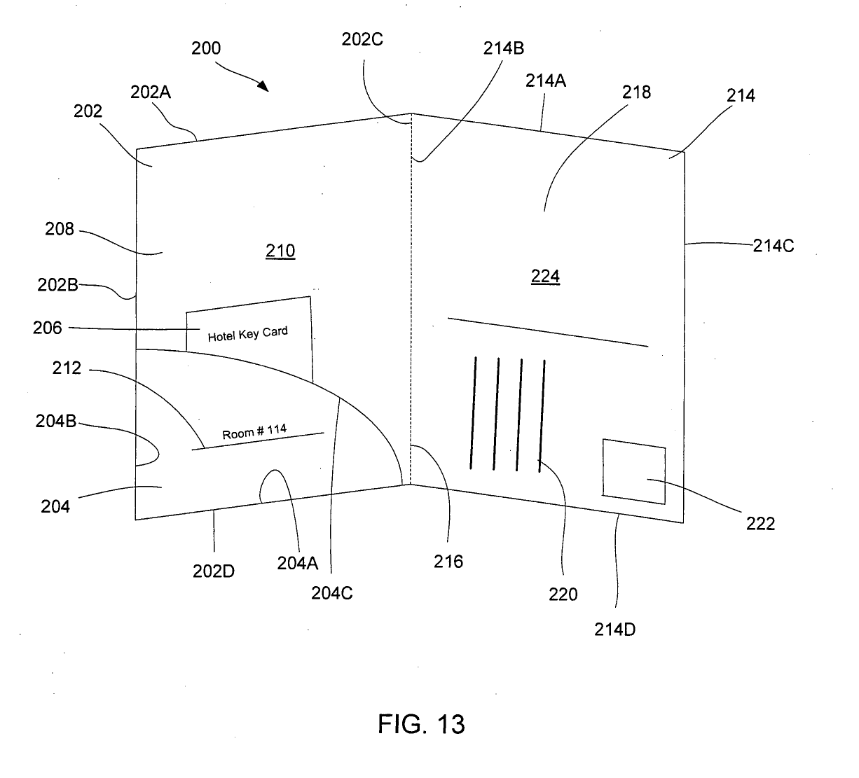

Referring now to FIG. 13, there is illustrated a front view of another embodiment of the present invention comprising a booklet, generally indicated at 200. The booklet 200 comprises a planar member 202. The planar member 202 may be preferably be formed from a relatively thin material, such as paper. The planar member 202 may preferably be substantially rectangular in shape having a top edge 202A, a side edge 202B, a side edge 202C, and a bottom edge 202D. It will be appreciated by those having ordinary skill in the art that the shape of the planar member 202 may take various forms other than rectangular and that illustrated in the figures. The planar member 202 further includes an inner surface 210.

The planar member 202 further includes an outer member 204 forming a holder for receiving a key card 206. The manner in which the outer member 204 forms a holder in conjunction with the planar member 202 will now be explained. The outer member comprises a bottom edge 204A, a side edge 204B, and a top edge 204C. The bottom edge 204A of the outer member 204 is attached to the bottom edge 202D of the planar member 202. The side edge 204B of the outer member 204 is attached to the side edge 202B of the planar member 202. The top edge 204C of the outer member 204 extends from the side edge 204B of the outer member 204 to the bottom edge 204A of the outer member 204. The top edge 204C is free from attachment to the planar member 202. The unattached top edge 204C of the outer member 204 allows the key card 206 to be inserted into the area formed between the outer member 204 and the inner surface 210 of the planar member 202. A location 212 on the outer member 204 may be provided for writing a hotel room number.

As used herein, the term “key card” is intended to encompass any type of useful generally planar article, whether or not such article is used to operate a lock and including articles which merely present information in a human readable form and presenting information in a machine readable form. Those skilled in the art will readily be able to select many different articles which fall within the scope of the term key card.

It will be appreciated that the holder may take other forms than the embodiment described in relation of FIG. 13. For example, in another illustrative embodiment of the present invention, the holder may comprise a slit in the planar member 202. In still another embodiment of the present invention, the key card may be attached to the planar member 202 using an adhesive. Thus, it will be appreciated that the present invention contemplates any structure, apparatus or device that may be utilized to hold a key card to the booklet 200 or planar member 202.

Attached to the planar member 202 is a card 214. The card 214 may comprise a substantially rectangular shape having a top edge 214A, a side edge 214B, a side edge 214C, and a bottom edge 214D. The planar member 202 and the card 214 are attached along side edges 202C and 214B, respectively. Disposed between the side edges 202C and 214B of the planar member 202 and the card 214, respectively, is a perforation 216. The perforation 216 serves to facilitate the separation of the planar member 202 and the card 214. It will be appreciated that other forms of attachment between the planar member 202 and the card 214 all fall within the scope of the present invention. For example, the planar member 202 and the card 214 may be attached together using an adhesive.

The card 214 may take various forms including a postcard as depicted in FIG. 13. As a postcard, the card 214 may include a message area 218, an address area 220, and a postage area 222 all disposed on a backside 224 of the card. The pre-paid postage may be affixed or printed in the postage area 222. Alternatively, a voucher may be printed in the postage area 222 informing the recipient of the booklet 200 that free postage and mailing are available by delivering the card 214 to a specified location. For example, the voucher may indicate that free postage and mailing are available by delivering the card 214 to a front desk of a hotel. The voucher may also be printed on the planar member 202 or on a piece of paper that can be inserted into the holder on the planar member 202. Exemplary language for the voucher may state: “Bring this postcard to the front desk and we will pay for postage and mail it for you.”

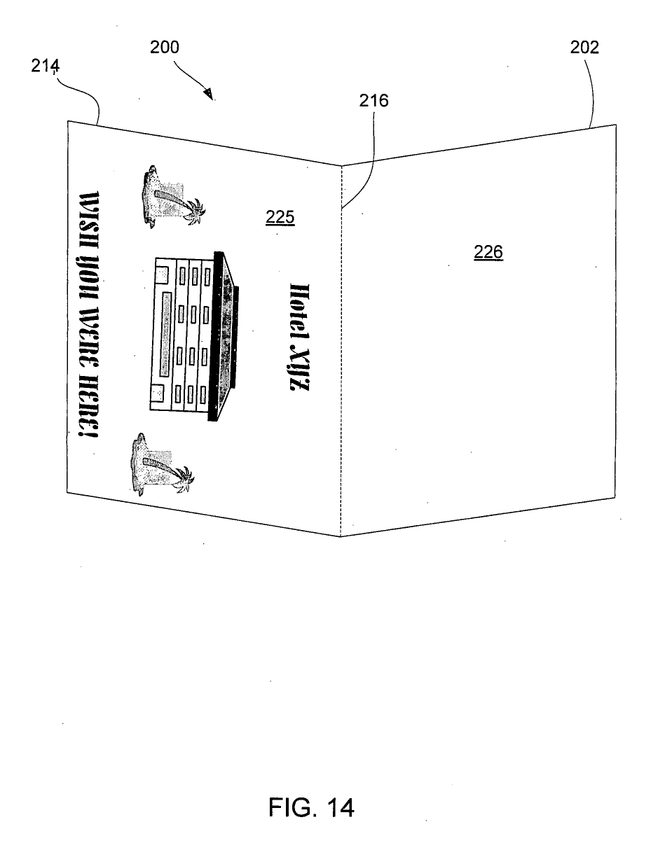

Referring now to FIG. 14, there is depicted a view of the outside of the booklet 200 shown in FIG. 13, where like reference numerals represent like components. On an outer surface 225 of the card 214 may be depicted any type of scene typically found on postcards and it will be appreciated that the graphical representation illustrated in FIG. 14 is merely exemplary of possible representations. An outer surface 226 of the planar member 202 may be utilized for additional promotional, marketing or information for the recipient of the booklet 200.

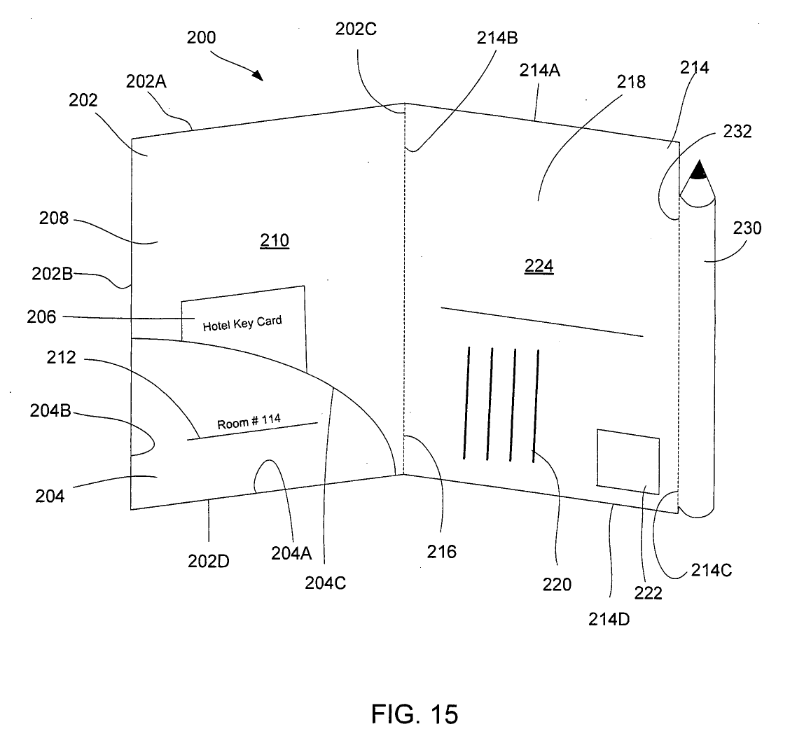

Referring now to FIG. 15, there is depicted another illustrative embodiment of the present invention where like reference numerals depict like components as shown and described in relation to FIGS. 13 and 14. Attached along the side edge 214C of the card 214 is a writing implement 230. A perforation 232 is disposed between the writing implement 230 and the side edge 214C and facilitates the removal of the writing implement 230 from the card 214. The writing implement 230 may then be utilized to write on the card 214.

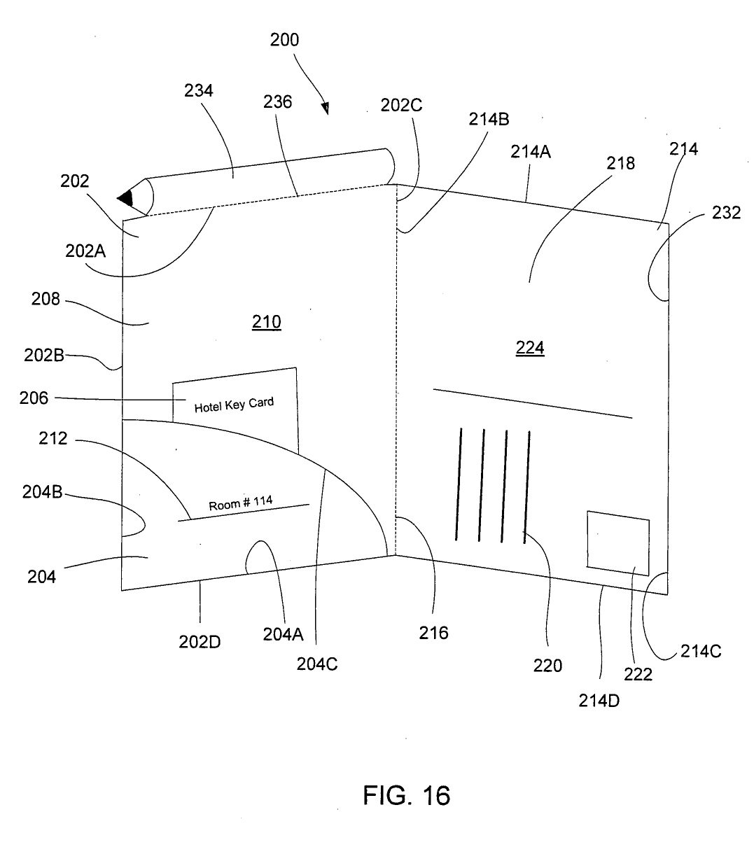

Referring now to FIG. 16, there is depicted another illustrative embodiment of the present invention where like reference numerals depict like components as shown and described in relation to FIGS. 13 and 14. Attached along the top edge 202A of the planar member 202 is a writing implement 234. A perforation 236 is disposed between the writing implement 234 and the top edge 202A and facilitates the removal of the writing implement 234 from the planar member 202. Once removed, the writing implement 234 may then be utilized to write on the card 214. Alternatively, the writing implement 234 may be attached to the planar member 202 in a variety of manners, including adhesive.

As mentioned, the card 214 may take other forms than that of a postcard. For example, the card 214 may include a coupon for a discount on a product or service. The card 214 may comprise a map to a local attraction or of a surrounding area. The card 214 may comprise advertising, including local, national, and global advertising. The card 214 may comprise local attraction information, such as theme parks, museums, and other areas of interest. The card 214 may comprise messages relaying information to the recipient of the booklet 200, such as a room checkout time. The card 214 may comprise a guest survey or a customer satisfaction survey to be returned to the provider of the booklet 200. The card 214 may comprise a sign-up, including sign-ups for tour groups, performances, meals, and special programs that are locally available. The card 214 may also comprise a menu and order form for room service.

As demonstrated above, embodiments of the present invention may be provided with or without prepaid postage. In the case where prepaid postage is not provided, a voucher for postage and mailing may be included either in print form or on a separate sheet. Further, embodiments may be provided with or without an attached writing implement.

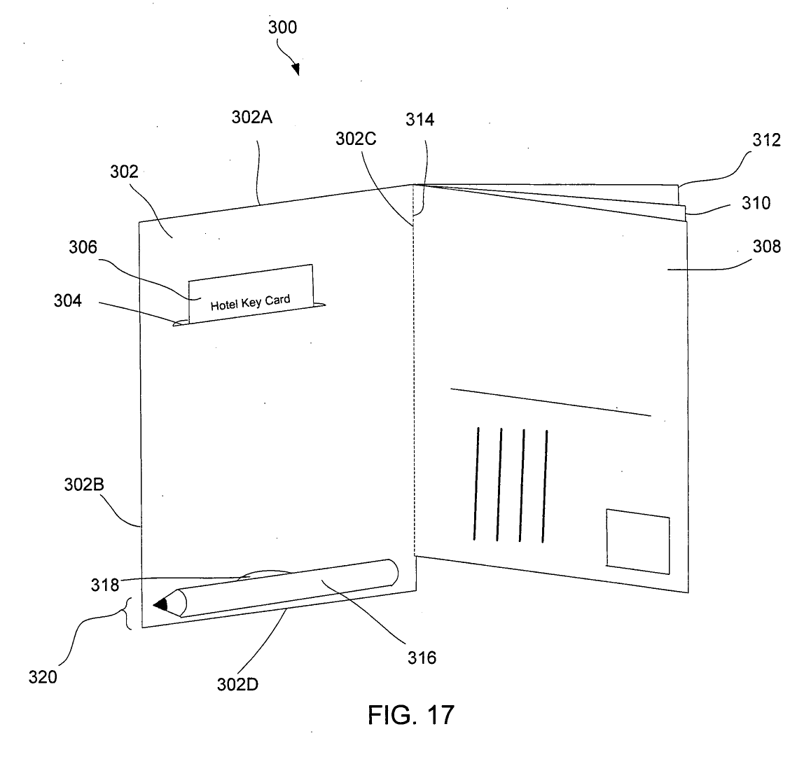

Referring now to FIG. 17, there is depicted a booklet, generally indicated at 300, in accordance with another illustrative embodiment of the present invention. Booklet 300 comprises a planar member 302 having a top edge 302A, a side edge 302B, a side edge 302C, and a bottom edge 302D. Formed in the planar member 302 is a slot 304 for receiving and holding a key card 306. Attached to the planar member 302 along the side edge 302C are cards 308, 310, and 312. The cards 308, 310, and 312 may be detached from the planar member 302 via a perforation 314.

It will be appreciated that although only three cards 308, 310, and 312 are depicted in FIG. 17, that any number of cards may be attached to the planar member 302. Cards 308, 310, and 312 may comprise postcards and may include pre-paid postage or a voucher for pre-paid postage as described above. It is an aspect of the present invention that the cards 308, 310, and 312 may take other forms than that of postcards. For example, the cards 308, 310, and 312 may include a coupon for a discount on a product or service. The cards 308, 310, and 312 may comprise a map to a local attraction or of a surrounding area. The cards 308, 310, and 312 may comprise advertising, including local, national, and global advertising. The cards 308, 310, and 312 may comprise local attraction information, such as theme parks, museums, and other areas of interest. The cards 308, 310, and 312 may comprise messages relaying information to the recipient of the booklet 200, such as checkout time. The cards 308, 310, and 312 may comprise a guest survey or a customer satisfaction survey to be return to the provider of the booklet 200. The cards 308, 310, and 312 may comprise a sign-up, including sign-ups for tour groups, performances, meals, and special programs that are locally available. The cards 308, 310, and 312 may comprise a menu and order form for room service.

A writing implement 316 may be attached to the planar member 302 adjacent the bottom edge 302D using an adhesive 318. The planar member 302 may have a lower portion 320 that extends below the bottom of the cards 308, 310, and 312 such that the booklet 300 will close with the writing implement 316 attached.

In one embodiment of the present invention, a hotel check-in kit is formed having a key card, and at least one card. The check-in kit is presented to a guest of the hotel upon arrival. The at least one card may be a postcard. Further, the kit may include pre-paid postage or a voucher for free mailing and free postage. The kit may also include cards in the form of coupons and advertising.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A correspondence device comprising:
a postcard having a front side and a back side; and
a writing implement removably attached to the postcard;
wherein said writing implement may be detached from the postcard and utilized to write a message on the postcard.

2. The device of claim 1 further comprising prepaid postage on the back side of the postcard.

3. The device of claim 1 further comprising a perforation to facilitate removing the writing implement from the postcard.

4. The device of claim 1 wherein the postcard includes a first portion, the first portion being wrapped around the writing implement in order to attach the writing implement to the postcard.

5. The device of claim 1 wherein the writing implement is attached to the postcard with an adhesive.

6. The device of claim 1 wherein the writing implement is releasably securable to the postcard.

7. The device of claim 1 wherein the postcard comprises at least one edge, the writing implement being attached to the postcard along the at least one edge of the postcard.

8. The device of claim 1 wherein the writing implement is disposed between the front side and the back side of the postcard.

9. The device of claim 1 wherein the postcard includes a side edge, the writing implement being attached to the postcard along the side edge of the postcard.

10. The device of claim 1 wherein the postcard is formed from at least two layers of a stock material, and the writing implement being disposed between the at least two layers of the postcard.

11. The device of claim 1 further including prepaid postage at the highest-international rate.

12. The device of claim 1 further including universal prepaid postage.

13. The device of claim 1, further comprising a second card removably attached to the writing implement.

14. The device of claim 11 further comprising a perforation for facilitating the removal of the second card from the writing implement.

15. The device of claim 1 further comprising a second postcard removably attached to the postcard.

16. The device of claim 15 further comprising a perforation for facilitating the removal of the second postcard from the postcard.

17. The device of claim 15 further comprising rejoinable structure for facilitating the removal of the second postcard from the postcard.

18. The device of claim 1 wherein the postcard is one of a plurality of postcards bound in booklet a form.

19. The device of claim 1 wherein the writing implement is disposed in a fold.

20. The device of claim 1 wherein the size of the postcard is selected from the group consisting of: 3.5 by 5 inches, 4 by 6 inches, 8.5 by 11 inches, 8.5 by 14 inches and A4 size.

21. A multi-pack set of postcards comprising:
a plurality of postcards;
a binding for holding the postcards together;
a means for individually separating the postcards from the binding; and
a holder for a writing implement.

22. The set of claim 21 wherein the means for separating the postcards from the binding comprises a perforation.

23. The set of claim 21 wherein the holder for the writing implement is integrated into the binding.

24. The set of claim 21 wherein each of the postcards includes prepaid postage.

25. The set of claim 24 wherein the prepaid postage comprises universal postage.

26. The set of claim 21 wherein the writing implement is selected from the group consisting of: a pen, a pencil and a marker.

27. The set of claim 21 wherein the holder for the writing implement is a slot in the binding.

28. The set of claim 21 further comprising a plurality of second cards, wherein one of the second cards is disposed between each of the postcards and the binding.

29. A correspondence device comprising:
a first card;
a second card;
a writing implement attached to the first and second cards;
wherein said writing implement may be detached from both the first and seconds cards in order to write a message on either the first or second cards.

30. The device of claim 29 wherein the second card is smaller than the first card.

31. The device of claim 29 wherein the first card is a postcard.

32. The device of claim 29 wherein the second card comprises a coupon.

33. The device of claim 29 wherein the second card comprises a sticker.

34. The device of claim 29 wherein the second card comprises a magnet.

35. The device of claim 29 wherein the second card displays information about the first card.

36. The device of claim 29 wherein the second card comprises an advertisement.

37. A method of forming a postcard with an integrated writing implement, said method comprising the steps of:
providing a piece of stock material having a first side and a second side;
placing the writing implement on the first side of the stock material such that the first side of the stock material is divided into a first surface and a second surface;
folding the first surface and the second surface around the writing implement;
and adhering the first surface and the second surface of the first side together to thereby form the postcard.

38. The method of claim 37 further comprising the step of making a perforation in the stock material such that the writing implement is detachable from the postcard.

39. The method of claim 37 further comprising the step of pre-printing on the stock material a front and back of a postcard.

40. The method of claim 37 further comprising the step of adding prepaid postage.

41. A correspondence device comprising:
a planar material having a front side and a back side; and
a writing implement attached to the material;
wherein said writing implement may be detached from the material and utilized to write on the material.

42. The device of claim 41 further comprising prepaid postage attached to the planar material.

43. The device of claim 41 further comprising a separation structure to facilitate detaching the writing implement from the material.

44. The apparatus of claim 41 wherein the writing implement is wrapped in a portion of the material.

45. The apparatus of claim 41 wherein the writing implement is removably attached to the material with an adhesive.

46. The apparatus of claim 41 wherein the writing implement is disposed along an edge of the material.

47. The apparatus of claim 41 wherein the writing implement is disposed between layers of the material.

48. A correspondence device comprising:
a first postcard;
a writing implement removably attached to the first postcard; and
a second postcard removably attached to the first postcard.

49. The device of claim 48 further comprising a third postcard removably attached to the second postcard.

50. The device of claim 48 further comprising a fourth postcard removably attached to the third postcard.

51. The device of claim 48 further comprising prepaid postage on each of the first, second, third and fourth postcards.

52. The device of claim 48 further comprising perforations to detach the writing implement and the second postcard from the first postcard.

53. An apparatus for holding a key card, said apparatus comprising:
a planar member having a holder for receiving the key card; and
a card removably attached to said planar member.

54. The apparatus of claim 53, further comprising a perforation disposed between the planar member and the card.

55. The apparatus of claim 53, wherein the holder comprises an outer member having a first edge and a second edge, said first and second edges of the outer member being attached to the planar member to thereby define the holder.

56. The apparatus of claim 53, wherein the holder comprises a slit in the planar member.

57. The apparatus of claim 53, wherein the holder comprises an adhesive.

58. The apparatus of claim 53, wherein the holder comprises a pocket.

59. The apparatus of claim 53, wherein the card is a postcard.

60. The apparatus of claim 59, further comprising pre-paid postage for the postcard.

61. The apparatus of claim 59, further comprising a writing area on the postcard.

62. The apparatus of claim 59, further comprising a redeemable voucher for free postage.

63. The apparatus of claim 62, wherein the redeemable voucher further includes free mailing.

64. The apparatus of claim 62, wherein the redeemable voucher is printed on the postcard.

65. The apparatus of claim 53, wherein the card comprises a coupon.

66. The apparatus of claim 53, wherein the card comprises a survey.

67. The apparatus of claim 53, wherein the card comprises a map.

68. The apparatus of claim 53, wherein the card comprises an advertisement.

69. The apparatus of claim 53, wherein the card comprises an early checkout form.

70. An apparatus for holding a key card, said apparatus comprising:
a planar member having a holder for receiving the key card;
a card removably attached to said planar member; and
a writing implement removably attached to the card.

71. The apparatus of claim 70, further comprising a perforation disposed between the writing implement and the card.

72. The apparatus of claim 71, further comprising a perforation disposed between the planar member and the card.

73. The apparatus of claim 70, wherein the card is a postcard.

74. The apparatus of claim 73, further comprising pre-paid postage for the postcard.

75. The apparatus of claim 73, further comprising a redeemable voucher for free postage.

76. The apparatus of claim 75, wherein the redeemable voucher further includes free mailing.

77. The apparatus of claim 75, wherein the redeemable voucher is printed on the postcard.

78. The apparatus of claim 70, wherein the card comprises a coupon.

79. The apparatus of claim 70, wherein the card comprises a survey.

80. The apparatus of claim 70, wherein the card comprises a map.

81. The apparatus of claim 70, wherein the card comprises an advertisement.

82. The apparatus of claim 70, wherein the card comprises an early checkout form.

83. An apparatus for holding a key card, said apparatus comprising:
a planar member having a holder for receiving the key card;
a card removably attached to said planar member; and
a writing implement removably attached to the planar member.

84. The apparatus of claim 83, further comprising a perforation disposed between the writing implement and the planar member.

85. The apparatus of claim 84, further comprising a perforation disposed between the planar member and the card.

86. The apparatus of claim 83, wherein the card is a postcard.

87. The apparatus of claim 86, further comprising pre-paid postage for the postcard.

88. The apparatus of claim 86, further comprising a redeemable voucher for free postage.

89. The apparatus of claim 88, wherein the redeemable voucher further includes free mailing.

90. The apparatus of claim 88, wherein the redeemable. voucher is printed on the postcard.

91. The apparatus of claim 83, wherein the card comprises a coupon.

92. The apparatus of claim 83, wherein the card comprises a survey.

93. The apparatus of claim 83, wherein the card comprises a map.

94. The apparatus of claim 83, wherein the card comprises an advertisement.

95. The apparatus of claim 83, wherein the card comprises an early checkout form.

96. A kit for a hotel guest, said kit comprising:
a key card; and
a postcard.

97. The kit of claim 96, further comprising pre-paid postage for the postcard.

98. The kit of claim 96, further comprising a writing implement.

99. The kit of claim 96, further comprising a voucher for free postage.

100. The kit of claim 99, further comprising a voucher. for free mailing.

101. The kit of claim 100, further comprising a coupon.
